(19) United States
(12) Patent Application Publication
(10) Pub. No.: US 2007/0262124 A1
(43) Pub. Date: Nov. 15, 2007

(54) Method and Device for Butt Welding Metal Sheets of Differing Thicknesses with the Aid of at Least One Height-Adjustable Tension Roller That is Located Below the Metal Sheets

(76) Inventors: Gerhard Alber, Ravensburg (DE); Martin Retzbach, Ravensburg (DE)

Correspondence Address: MCGLEW & TUTTLE, PC, P.O. BOX 9227, SCARBOROUGH STATION, SCARBOROUGH, NY, 10510-9227, US

(21) Appl. No.: 10/596,391

(22) PCT Filed: Sep. 23, 2004
(86) PCT No.: PCT/EP04/10670

§ 371 Date: Mar. 22, 2007

(30) Foreign Application Priority Data
Dec. 11, 2003 (DE) 103 57 891.9

(51) Int. Cl. B23K 31/02; B23K 37/04

(52) U.S. Cl. 228/212; 228/4.1

(57) ABSTRACT

The invention relates to a method for butt welding metal sheets (1, 2), preferably sheet metal strips or blanks of differing thicknesses by the relative displacement of a laser beam or electron beam in relation to the metal sheets (1, 2), along the line of contact of said sheets (1, 2) or the line of the welding seam that is to be produced, with the aid of tension rollers (4, 5, 10) that are located in pairs at a distance from one another above and below the sheets (1, 2) in the vicinity of the welding seam. The tension rollers (10) that are located above the sheets (1, 2) roll off the latter (1, 2) in a height-adjustable and/or sprung manner. The height of the tension rollers (4, 5) that are located below the sheets (1, 2) on at least one side of the welding seam is adjusted.

### SPECIFICATION

The present invention pertains to a method for butt welding metal sheets of differing thicknesses according to the preamble of claim 1 and to a device for carrying out the method according to the preamble of patent claim 4.

A device for the continuous welding of strips or metal sheets guided in abutting relationship by means of at least one stationary laser beam with tension rollers arranged in pairs on both sides of the strips or metal sheets to be welded together at right angles to the direction of motion of the strips or metal sheets is known from EP 299 358 B1. The upper tension rollers are mounted here in a vertically movable manner in rockers movable independently from one another in order to roll on the metal sheets in a suitable manner. As a result, the upper tension rollers can assume different levels especially during the butt welding of metal sheets of differing thicknesses. The two tension rollers arranged below the metal sheets to be welded together are arranged stationarily, i.e., they are not adjustable in height and thus form a uniform, flat support for the metal sheets to be welded together.

DE 93 14 720 U1 describes a device for smoothing weld seams prepared before on relatively thin metal sheets, where a support roller each is arranged above the metal sheets, namely, in the immediate area of the weld seam, and a smoothing roller, which can be fed and locked, is arranged below the metal sheets, in order to eliminate or at least smooth a bead of the weld seam that may possibly be present on the underside of the metal sheets after welding.

Finally, EP 713 746 B1 describes a device and a method for butt welding flat metal sheets of differing thicknesses by means of a laser beam, wherein the jump in thickness between the two metal sheets is arranged on the underside and the metal sheets undergo plastic deformation in the area of the thickness jump before the welding operation. The upper metal sheet holding plates and a lower carrying structure are shaped correspondingly for this purpose.

Even though it is described in the state of the art that the thickness jump between the metal sheets is arranged either above or below the metal sheets, no provisions are, however, made for a changeover of the device from thicker and thinner metal sheets and especially for a changeover of the thickness jump from top to bottom and vice versa in these welding devices.

The basic object of the present invention is therefore to propose a method of this class and a device for carrying out this method, in which the arrangement of the thick metal sheet and the thin metal sheet and especially the arrangement of the thickness jump can be varied as desired with one and the same device.

This object is accomplished with the independent claims 1 and 4. Additional suggestions concerning the method are contained in claims 2 and 3.

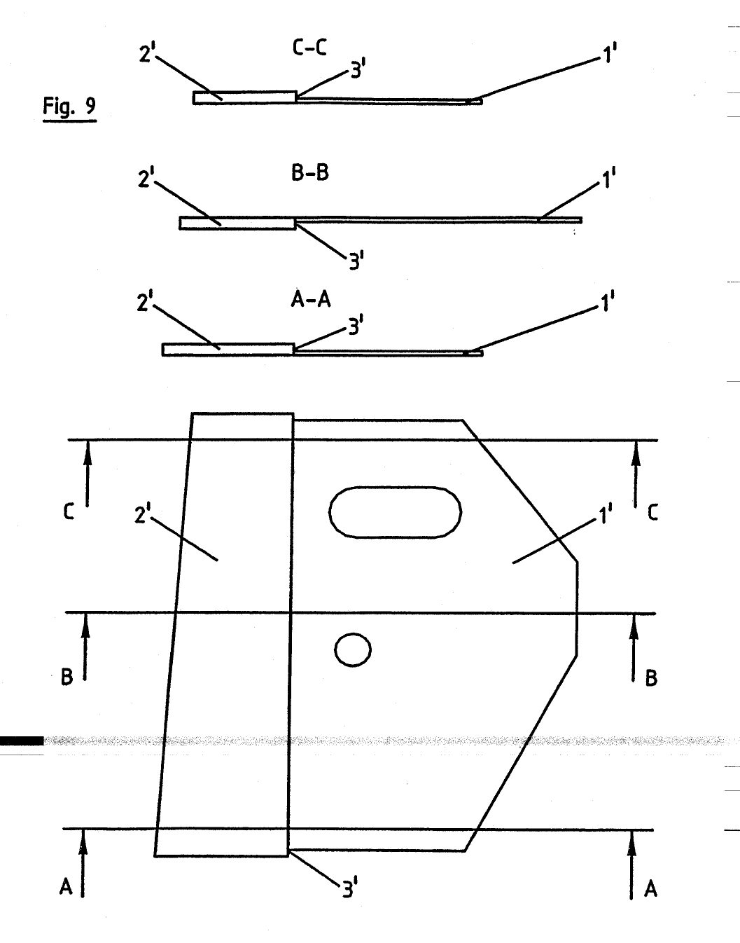

Provisions are made in the method according to the present invention and in the device for carrying out this method for the tension rollers to be also able to be adjusted in height below the metal sheets at least on one side of the weld seam, besides the metal sheets [“Blechen” in line 21, p. 2 of German original is an obvious typo for “Spannrollen” meaning “tension rollers”—Tr.] rolling on the top side of the metal sheet in a vertically movable and/or spring-loaded manner. Preferably only one of the two tension rollers arranged below the metal sheets is adjustable in height, while the other roller is arranged stationarily on the support. “Adjustable in height” means here that no elastic support is provided for this tension roller, but it is adjustable preferably as a function of the preset thickness and/or preset, necessary height position of the metal sheet. It has also proved to be favorable, in particular, to change or adjust the height of a lower tension roller during the ongoing welding operation, so that the relative positions of the two metal sheet edges abutting against each other can be changed over the course of the weld seam, e.g., in a sinusoidal pattern or according to a defined, preset curve. A so-called thickness jump can thus be obtained fully or partially within a component, e.g., from the bottom side of the metal sheets the top side of the metal sheets and back again (cf. FIG. 9).

For the adjustment, the lower tension rollers may be preferably arranged at a bearing that is adjustable in height on vertical guide rails with a simple drive for height adjustment.

Contrary to the state of the art, any desired changeover of the thickness jump is possible with the method according to the present invention in the area of the weld seam between the top side and the bottom side of the metal sheets. In addition, as is also apparent from the attached figures, any desired changeover of the thicker metal sheet from left to right is possible as well. This is especially advantageous when components that are needed for the left-hand side and the right-hand side of a passenger car and must have a mirror inverted design must be manufactured. The manufacture of such mirror inverted components was not provided for and was not possible or was possible only after a complicated rotation and repositioning of the corresponding metal sheets of the component only with the state of the art. Such a rotation and repositioning is not necessary according to the present invention. As is apparent from the description of the figures, both mirror inverted components (cf. FIGS. 7 and 8) and components with alternating thickness jump in the course of a weld seam can be manufactured by the simple height adjustment of a lower tension roller.

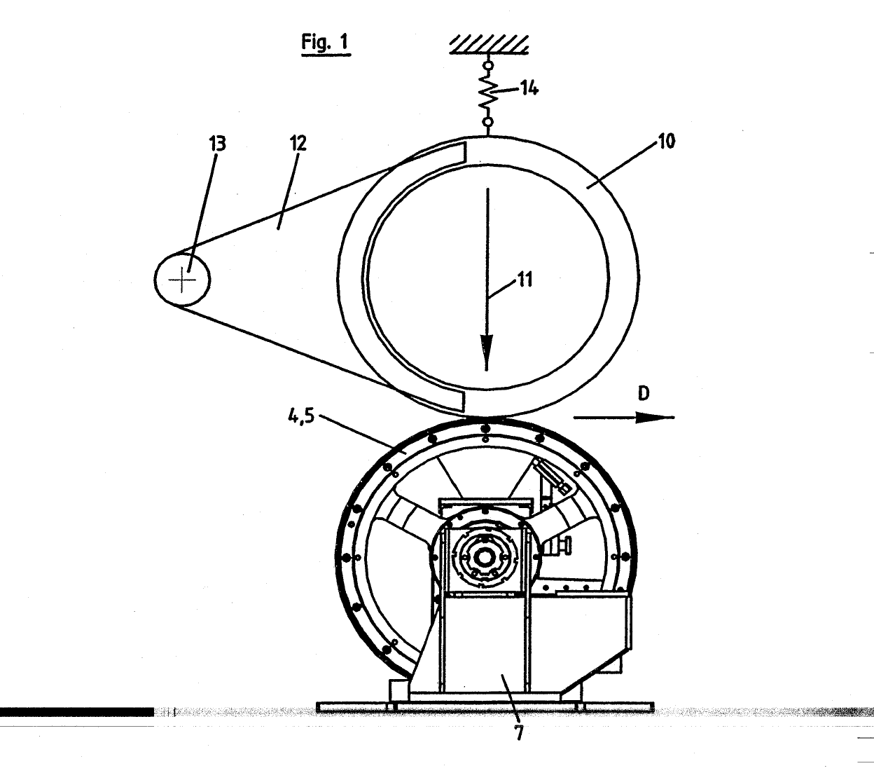

The present invention will be explained in greater detail as an example on the basis of FIGS. 1 through 9 attached. In the drawings,

FIG. 1 show a side view of the tension rollers 4, 5, 10 arranged below and above the metal sheets 1, 2 during welding,

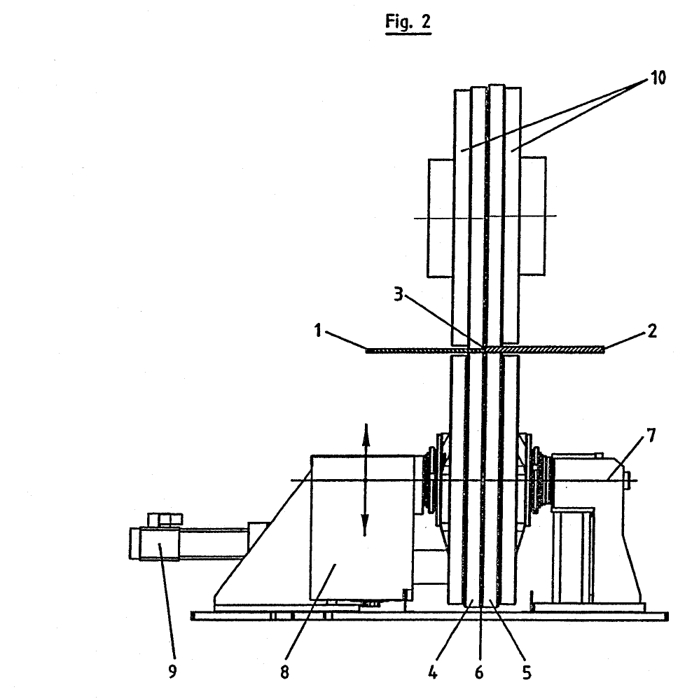

FIGS. 2 through 6 show different front views of the tension rollers 4, 5 and 10 with different positions of the thickness jump 3 and of the height-adjustable tension roller 4, and

FIGS. 7 through 9 show a top view and a sectional view of different components fitted together from the metal sheets 1, 2 and 1′, 2′.

In the side view of the entire welding device, FIG. 1 shows only the associated tension rollers 4, 5 and 10, between which the metal sheets are guided in the direction of passage D during the welding operation. The upper tension roller 10 is fastened here in the known manner to a rocker 12, which is suspended essentially on the spring 14 and is adjustable in height about the horizontal axis of rotation of the bearing block 13. The laser beam arranged [sic—probably typo for word meaning “indicated”—Tr.] by the arrow 11 is directed within the upper tension roller 10 between the two tension rollers 10 (cf. FIG. 2) toward the contact line between the two metal sheets 1, 2. Since the metal sheets 1, 2 and 1′, 2′ preferably have different thicknesses in the area of the laser weld seam, the thickness jump designated by 3, 3′ is obtained there. This thickness jump is arranged on top in the normal case according to FIG. 2, the two undersides of the metal sheets 1, 2 forming a flat surface in the area of the weld seam. In this case, the height-adjustable tension roller 4 is also in its so-called zero position, at the same level as the opposite tension roller 5 arranged at the stationary bearing 7. The upper tension roller 10 arranged on the right-hand side of the weld seam lies on the thicker metal sheet 2 and the left-hand tension roller 10 on the thinner metal sheet 1. In the same manner, the thicker metal sheet 2 could also be arranged on the left and the thinner metal sheet 1 on the right of the weld seam in the view according to FIG. 2. However, the thickness jump 3 between the two metal sheets is at the top in both cases.

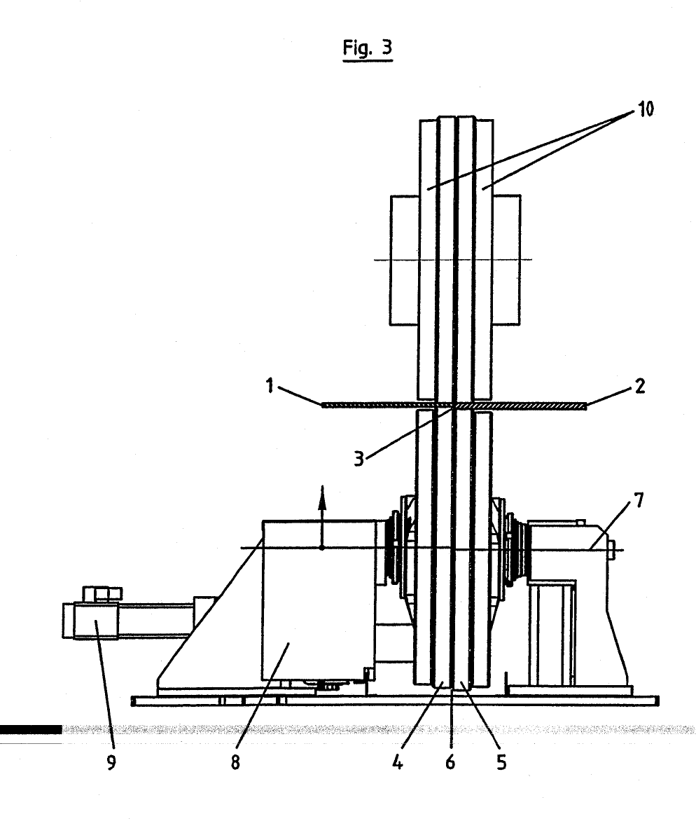

In FIGS. 3 and 4, the thickness jump is at the bottom, so that the top sides of the two metal sheets form a horizontal plane, on which the two tension rollers 10 roll at the same level. In the view according to FIG. 3, the thinner metal sheet 1 is arranged on the left and the tension roller 4 located under it is adjusted upward in relation to the zero position according to FIG. 2 by the corresponding difference in height by means of the height-adjustable bearing 8 and of the corresponding drive 9. In the view according to FIG. 4, in which the thicker metal sheet 2 is arranged on the left[,] the tension roller 4 is adjusted downward from the zero position by the difference in thickness. The height position of the tension roller 5 remains unchanged in all cases. The upper tension rollers 10 automatically assume the height position that is determined by the metal sheet located on the tension roller 5 on the right. Consequently, only the height position of the left-hand tension roller 4 must be adjusted.

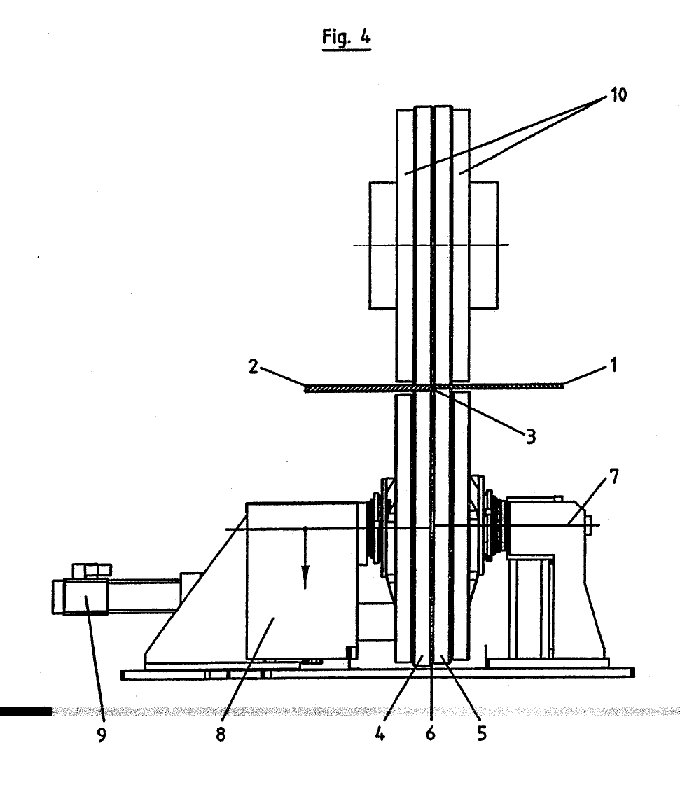

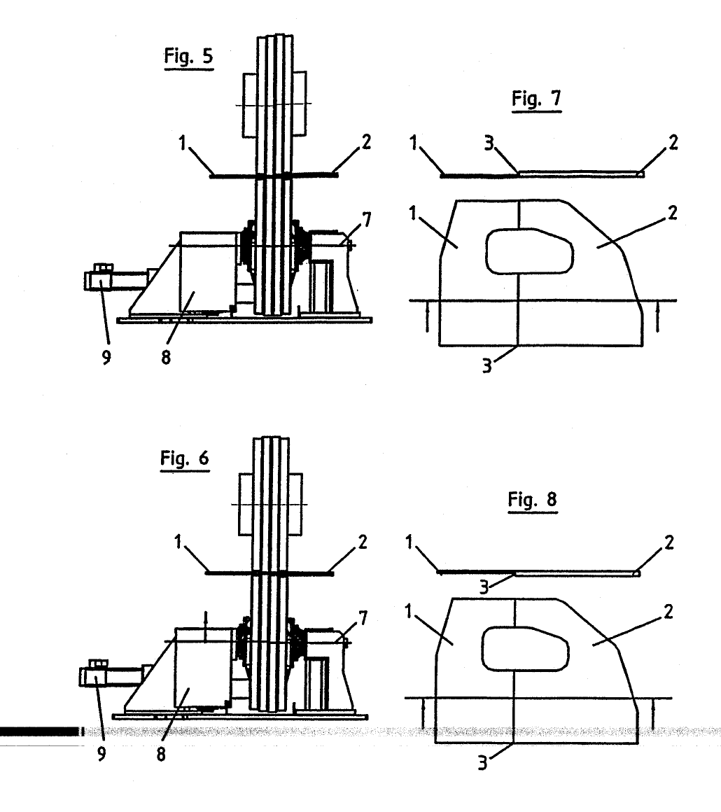

FIGS. 7 and 8 show a top view and a sectional view of two mirror inverted components, FIG. 7 showing the thickness jump 3 at the top and FIG. 8 showing the thickness jump 3 at the bottom, the thin metal sheet 1 being located on the left and the thick metal sheet 2 on the right in both cases. FIGS. 5 and 6, arranged next to these figures, show once again FIGS. 2 and 3 on a smaller scale and in a somewhat more schematic form.

In its lower area, FIG. 9 shows a top view of another component fitted together from the metal sheets 1′ and 2′. The peculiarity here is that the thickness jump 3′ within this component along the weld seam is changed continuously only by the height adjustment of the tension roller 4 during the welding operation. The thickness jump 3′ is arranged a the top in the area of the section lines A-A and C-C, whereas it is arranged at the bottom in the area of the section line B-B. Consequently, the location of the thickness jump 3′ changes, preferably continuously, starting from the two ends of the weld seam, so that either the right-hand metal sheet 1′ or the left-hand metal sheet 2′ has an arc shape in the area of the weld seam. It is, of course, most simple if the thicker metal sheet 2′ extends on the stationary tension roller 5 and the thin metal sheets [“Bleche” meaning “metal sheets” in line 20, pp. 5 of German original is a typo for “Blech” meaning “metal sheet”—Tr.] extends on the height-adjustable tension roller 4 and only the thinner metal sheet is deformed in an bottom-shaped manner [“bodenförmig” in line 22, p. 5 of German original is an obvious typo for “bogenförmig” meaning “in an arc-shaped manner”—Tr.].

### List of Reference Numbers

1, 1′ Metal sheet (thin)
2, 2′ Metal sheet (thick)
3, 3′ Thickness jump between 1 and 2 or 1′ and 2′ (at bottom or at top)
4 Tension roller
5 Tension roller
6 Gap between 4 and 5
7 Bearing for 5 (stationary)
8 Bearing for 4 (height-adjustable)
9 Drive for height adjustment
10 Tension rollers (top)
11 Laser beam
12 Rocker at 13
13 Bearing block
14 Spring
D Direction of passage for 1, 2

1. A method for butt welding metal sheets, preferably strips of metal sheet or steel sheet billets of differing thickness, the method comprising:
providing relative motion between a laser beam or electron beam and said metal sheets along the contact line between said metal sheets or the weld seam to be prepared with tension rollers arranged in pairs above and below said metal sheets at spaced location from one another and next to said weld seam along said contact line of said metal sheets or said weld seam to be prepared, wherein said tension rollers include tension rollers arranged above said metal sheets that are movable in height and/or roll on said metal sheets in a spring-loaded manner, and wherein said tension rollers include tension rollers arranged below said metal sheets including a tension roller on one side of the said weld seam that is adjusted in height.

2. A method in accordance with claim 1, wherein said tension rollers are adjusted in height as a function of the thickness and/or the necessary height position of said corresponding metal sheet.

3. A method in accordance with claim 1, wherein the height of one of said tension rollers is changed and the height of another tension roller is fixed during the ongoing welding operation.

4. A device for butt welding said metal sheets, preferably metal sheet strips or steel sheet billets of differing thickness for carrying out the welding method, the device comprising:
a laser beam or electron beam; and
tension rollers arranged in pairs at spaced locations from one another next to said weld seam above and below said metal sheets allowing relative motion between said laser beam or said electron beam and the metal sheets along a contact line between the metal sheets or a weld seam to be prepared, and said tension rollers including tension rollers arranged above said metal sheets that are movable in height and/or roll on said metal sheets in a spring-loaded manner, and including at least one of said tension rollers arranged below said metal sheets that is arranged on a bearing that is adjustable in height on a vertical guide rail.

5. A method for butt welding metal sheets, the method comprising:
providing a laser beam or electron beam;
providing upper tension rollers and supported above the metal sheets so as to be movable in height and/or roll on the metal sheets in a spring-loaded manner;
providing lower tension rollers arranged below the metal sheets with one of said lower tension rollers being on one side of the weld seam and being adjustably mounted to be adjusted in height.

6. A method in accordance with claim 5, further comprising:
adjusting the height of said one of said lower tension rollers adjustably mounted on one side of the weld seam; and
subsequent to said step of adjusting the height, fixing a height position of said one of said lower tension rollers adjustably mounted on one side of the weld seam for but welding the sheets.

7. A method in accordance with claim 6, wherein said step of adjusting the height includes adjusting the height of said one of said lower tension rollers adjustably mounted on one side of the weld seam as a function of the thickness and/or the necessary height position of said corresponding metal sheet which said one of said lower tension rollers adjustably mounted on one side of the weld seam is in contact.

8. A method in accordance with claim 7, wherein the height of said one of said lower tension rollers adjustably mounted on one side of the weld seam is adjusted while maintaining fixed the height position of another of said lower tension rollers.
